(19) United States
(12) Patent Application Publication
(10) Pub. No.: US 2026/0356719 A1
(43) Pub. Date: Nov. 12, 2026

(54) Apparatus and Method for Implementing Advanced Nitrogen and Phosphorus Removal From Low Carbon-to-Nitrogen Ratio Wastewater Through Autotrophic Coupling with Heterotrophic Based on Continuous-Flow Membrane Aerated Biofilm Reactor

(71) Applicant: Beijing University of Technology, Beijing (CN)

(72) Inventors: Rui DU, Beijing (CN); Kexuan ZONG, Beijing (CN); Shenbin CAO, Beijing (CN); Fangzhai ZHANG, Beijing (CN); Yongzhen PENG, Beijing (CN)

(21) Appl. No.: 19/440,981

(22) Filed: Jan. 6, 2026

Related U.S. Application Data
(63) Continuation of application No. PCT/CN2025/133031, filed on Nov. 6, 2025.

(30) Foreign Application Priority Data
May 9, 2025 (CN) 202510598894.7

(51) Int. Cl. C02F 11/04; C02F 3/00; C02F 3/28; C02F 101/10; C02F 101/16

(52) U.S. Cl. CPC C02F 11/04; C02F 3/006; C02F 3/2853; C02F 2101/105; C02F 2101/163; C02F 2209/03

(57) ABSTRACT

Provided are an apparatus and method for implementing advanced nitrogen and phosphorus removal from low carbon-to-nitrogen ratio wastewater through autotrophic coupling with heterotrophic based on a continuous-flow membrane aerated biofilm reactor (MABR). A hollow fiber membrane is provided in the continuous-flow system; an oxygen concentration gradient is formed by the bubble-free film aeration technology. In the biofilm zone, the spatial partitioning for functional bacteria such as nitrifying bacteria and anammox bacteria is established. In two anoxic zones, the highly efficient nitrogen removal is achieved through partial denitrification coupling anammox and simultaneous nitrification-denitrification. In terms of phosphorus removal, the system of this application adopts an anaerobic-aerobic operating mode, polyphosphate-accumulating organisms are used to release phosphorus in a anaerobic condition and to uptake phosphorus in a aerobic condition, and the phosphorus removal is ultimately achieved through excess sludge discharge. In this system, an internal carbon source extraction process is integrated.

### CROSS REFERENCE TO RELATED APPLICATION

This application is a continuation application under 35 U.S.C.§111(a) of International Patent Application No. PCT/CN2025/133031, filed Nov. 06, 2025, which claims priority of the Chinese Patent Application No. 202510598894.7, filed with the China National Intellectual Property Administration on May. 09, 2025, and entitled "APPARATUS AND METHOD FOR IMPLEMENTING ADVANCED NITROGEN AND PHOSPHORUS REMOVAL FROM LOW CARBON-TO-NITROGEN RATIO WASTEWATER THROUGH AUTOTROPHIC COUPLING WITH HETEROTROPHIC BASED ON CONTINUOUS-FLOW MEMBRANE AERATED BIOFILM REACTOR", both of which are incorporated herein by references in their entities.

### TECHNICAL FIELD

The present disclosure relates to a technology for implementing advanced nitrogen and phosphorus removal from low carbon-to-nitrogen ratio wastewater through autotrophic coupling with heterotrophic based on a continuous-flow membrane aerated biofilm reactor (MABR), and belongs to the field of biological wastewater treatment.

### BACKGROUND

With the acceleration of urbanization, the municipal wastewater treatment faces the dual challenges of meeting discharge standards and reducing energy consumption. In recent years, although the organic pollution has been controlled to a certain extent, the excessive discharge of nutrients such as nitrogen and phosphorus makes the water eutrophication increasingly serious. Thus, the nitrogen and phosphorus removal has become a major demand in the control of water pollution. However, the municipal wastewater in China generally exhibits low carbon-to-nitrogen ratio characteristics. The conventional nitrogen removal process requires substantial energy consumption for aeration and additional organic carbon sources, while also being accompanied by secondary pollution issues such as massive excess sludge disposal and greenhouse gas emissions. Therefore, the development of low-carbon and high-efficiency advanced nitrogen removal technologies has become an urgent need in the current wastewater treatment field.

The partial denitrification/anammox (PD/A) process is an innovative two-step biological nitrogen removal technology. In the PD/A process, nitrate is first reduced into nitrite through partial denitrification (PD) under anoxic conditions, and then the nitrite and ammonia nitrogen are directly converted into a nitrogen gas through anaerobic ammonium oxidation (Anammox). The PD/A process breaks through the limitations of traditional nitrification and denitrification, theoretically requiring no additional carbon source or aeration, offering advantages such as low energy consumption and reduced sludge production, and this process is particularly suitable for the treatment of low C/N wastewater. However, there are still technical bottlenecks in the practical applications: the carbon source needs to be accurately controlled to maintain the nitrite accumulation, which may lead to additional carbon source consumption. Fluctuations in parameters such as dissolved oxygen (DO), pH can easily affect the activity of functional microbial communities. The substrate competition between heterotrophic denitrifying bacteria and anammox bacteria can reduce the nitrogen removal efficiency. Moreover, the fluctuation in the quality of influent can threaten the stability of nitrite accumulation, resulting in high requirements on process control.

The MABR system is a novel wastewater treatment system that combines a gas separation membrane technique and a biofilm treatment technique. MABR can achieve an oxygen transfer efficiency of nearly 100% through a unique bubble-free aeration mechanism. In the MABR system, a layered ecological structure of an aerobic-anoxic microenvironment is spontaneously formed inside a biofilm, enabling the high-efficiency implementation of simultaneous nitrification and denitrification (SND), significantly enhancing the nitrogen removal performance. The core technological advantages of MABR are as follows:
1) The dissolved oxygen can be accurately controlled through a membrane medium.
2) The functional partitioning for a biofilm is optimized to improve the distribution of microbial community.
3) The operational stability and treatment efficiency of the system are significantly enhanced. Additionally, the MABR system also exhibits outstanding characteristics such as compact structure, energy conservation, and excellent process compatibility.

The coupling of MABR with the PD/A process enables the synchronous construction of a layered biofilm structure including aerobic, anoxic, and anaerobic layers in a single reactor, and can achieve the efficient coupling of partial nitrification, denitrification, and anammox. Furthermore, this reactor can protect functional microbial communities through biofilm immobilization, and can significantly improve the impact load resistance of the system. Compared to the conventional process, the energy consumption is reduced by more than 50%, the sludge production is reduced by 40% to 60%, and the footprint is saved by 30%, making it particularly suitable for the advanced nitrogen removal from low carbon-to-nitrogen ratio wastewater. Additionally, this reactor is a continuous-flow system with strong practicality suitable for large-scale wastewater treatment plants. Through the modular series design, this reactor can flexibly adapt to different water quality needs, and reduce the footprint. This reactor has low requirements on automation control, and involves low energy consumption. The effluent from MABR reactor in the post-anoxic zone is treated in an anaerobic sludge fermentation tank. Through anaerobic fermentation, particulate organic matters (such as polysaccharides and proteins) in the sludge can be hydrolyzed into soluble organic matters (such as volatile fatty acids (VFAs)), and these soluble organic matters can be recycled as high-quality carbon sources for biological nitrogen removal system, reducing the need for external carbon supplementation, especially suitable for the treatment of low C/N ratio wastewater.

Addressing the dual demands of advanced nitrogen removal and energy conservation for low carbon-to-nitrogen ratio wastewater in the municipal wastewater treatment, and considering the limitations of the existing technologies, a synergistic nitrogen removal process coupling MABR with PD/A is proposed in the present disclosure. The synergistic nitrogen removal process optimizes the dissolved oxygen distribution through the bubble-free aeration of MABR and the layered biofilm structure, strengthens the efficient coupling of partial denitrification with anammox, and combines a sludge fermentation-based carbon recovery technology to form a sustainable nitrogen removal system with low energy consumption and low sludge yield, thereby offering an innovative solution for the advanced nitrogen removal and resource utilization of urban wastewater.

### SUMMARY

Based on the partial denitrification/anammox process, the membrane aerated biofilm reactor system, the aerobic aeration process, the anaerobic fermentation process, and the wastewater treatment process control technology, the present disclosure provides a deep nitrogen and phosphorus removal process that enables the SND-enhanced anammox with a continuous-flow MABR system, so as to achieve the efficient nitrogen and phosphorus removal from urban wastewater with a low carbon-to-nitrogen ratio.

The objective of the present disclosure is achieved by the following technical solutions:

An apparatus for implementing advanced nitrogen and phosphorus removal from low carbon-to-nitrogen ratio wastewater through autotrophic coupling with heterotrophic based on a continuous-flow membrane aerated biofilm reactor (MABR) is provided, including a municipal wastewater tank, an anaerobic tank, an anoxic-zone MABR tank, an aerobic aeration tank, a post-anoxic-zone MABR tank, a sedimentation tank, a sludge carbon source extraction system, an intermediate water tank, and an effluent tank. The anaerobic tank is provided with a first water inlet pipe, a first peristaltic pump, a first water inlet, a first pH probe, a first DO probe, a first multi-parameter measuring instrument, a first sludge inlet, and a first stirring device; the anoxic-zone MABR tank is provided with a first MABR membrane module, a first gas supply pipe, a second multi-parameter measuring instrument, a second pH probe, a second DO probe, a second stirring device, an internal return water inlet, a first pressure sensor, a first aeration valve, and a blower; the aerobic aeration tank is provided with a third stirring device, a fourth stirring device, a second gas supply pipe, and an aerator head; the post-anoxic-zone MABR tank is provided with a second MABR membrane module, an internal carbon source return port, a third gas supply pipe, a third aeration valve, a third pressure sensor, a first water outlet, a second peristaltic pump, and a return pipe; the sedimentation tank is provided with a second water inlet, a third peristaltic pump, a first water outlet pipe, a first sludge discharge pump, a first sludge delivery pipe, a second sludge discharge pump, a second sludge delivery pipe, and a second water outlet; the sludge carbon source extraction system is provided with a second sludge inlet, an exhaust port, a condensated water outlet, a third water outlet, a condensated water inlet, a fifth stirring device, a fourth peristaltic pump, and a second water outlet pipe; the intermediate water tank is provided with a fifth peristaltic pump and a carbon source pipe. The municipal wastewater tank is connected to the anaerobic tank through the first peristaltic pump; and the anaerobic tank, the anoxic-zone MABR tank, the aerobic aeration tank, and the post-anoxic-zone MABR tank are connected sequentially in the continuous-flow system; the post-anoxic-zone MABR tank is connected to the sedimentation tank through the third peristaltic pump; a part of effluent is returned to the anoxic-zone MABR tank through the second peristaltic pump; effluent from the sedimentation tank flows to the effluent tank; a part of sludge is delivered to the sludge carbon source extraction system for fermentation through the first sludge discharge pump, and the remaining part of the sludge is returned to the anaerobic tank through the second sludge discharge pump; and the sludge carbon source extraction system is connected to the intermediate water tank through the fourth peristaltic pump, and the intermediate water tank is connected to the post-anoxic-zone MABR tank through the fifth peristaltic pump to supply a carbon source for the post-anoxic-zone MABR tank.

A method for implementing advanced nitrogen and phosphorus removal from low carbon-to-nitrogen ratio wastewater through autotrophic coupling with heterotrophic based on continuous-flow membrane aerated biofilm reactor (MABR) is provided, including the following steps:
in a first step, setting an operating mode of a continuous-flow system dividing the continuous-flow system into an anaerobic tank, an anoxic-zone MABR tank, an aerobic aeration tank, and a post-anoxic-zone MABR tank that are in a volume ratio range of 2:2:2:1 to 2:2:4:1; allowing municipal wastewater to enter the anaerobic tank, the anoxic-zone MABR tank, the aerobic aeration tank, and the post-anoxic-zone MABR tank of the continuous-flow system successively; allowing excess sludge to enter a sludge carbon source extraction system; allowing a sludge fermentation product to enter the post-anoxic-zone MABR tank supplied for partial denitrification (PD); returning return sludge to the anaerobic tank; and partially returning effluent from the post-anoxic-zone MABR tank partially to the anoxic-zone MABR tank, achieving advanced nitrogen removal;
in a second step, setting parameters and starting and operating the system, at a startup stage, inoculating sludge into each reaction tank; inoculating excess sludge from a wastewater treatment plant into the anaerobic tank and making the anaerobic tank within at a sludge concentration range of 3.0 gVSS/L to 6.0 gVSS/L; inoculating the excess sludge and anammox sludge from the wastewater treatment plant into the anoxic-zone MABR tank and making the anoxic-zone MABR tank within a sludge concentration range of 4.0 gVSS/L to 8.0 gVSS/L; inoculating the excess sludge from the wastewater treatment plant into the aerobic aeration tank and making the aerobic aeration tank within a sludge concentration range of 2.0 gVSS/L to 5.0 gVSS/L; and inoculating the excess sludge and the anammox sludge from the wastewater treatment plant into the post-anoxic-zone MABR tank and making the post-anoxic-zone MABR tank within a sludge concentration range of 4.0 gVSS/L to 8.0 gVSS/L; and partially returning the effluent from the post-anoxic-zone MABR tank to the anoxic-zone MABR tank, where a mixed liquor return ratio is in a range of 200% to 400%, and a sludge return ratio in a sedimentation tank is in a range of 70% to 80%;
in the anaerobic tank, initially, setting an organic load of influent to 0.1 kgCOD/(m³·d) to 0.2 kgCOD/(m³·d), an influent flow rate to 10 m³/h to 20 m³/h, a hydraulic retention time to 4.0 h to 6.0 h, and a dissolved oxygen below 0.2 mg/L; and when a phosphorus concentration in effluent of the anaerobic tank is 2 times to 3 times higher than a phosphorus concentration in influent of the anaerobic tank, the anaerobic tank continuously and stably operates for more than 7 days, and a sludge concentration in the anaerobic tank is greater than or equal to 3.0 gVSS/L, indicating that the anaerobic tank is successfully started;
in the anoxic-zone MABR tank, turning on a blower and an aeration device; adopting a pulse aeration mode with an aerating time of 40 min and a rest time of 20 min, controlling a membrane aeration pressure in a range of 15 KPa to 25 KPa; controlling a dissolved oxygen concentration in a range of 0.2 mg/L to 0.5 mg/L and a hydraulic retention time in a range of 4.0 h to 6.0 h; and when an ammonia nitrogen removal rate is higher than 60% and a nitrate nitrogen removal rate is higher than 80% in the anoxic-zone MABR tank, the anoxic-zone MABR tank continuously and stably operates for more than 7 days, and a sludge concentration on a biofilm of MABR is higher than or equal to 1.0 gVSS/L, indicating that the anoxic-zone MABR tank is successfully started;
in the aerobic aeration tank, turning on a blower and an aeration device; controlling an aeration intensity in a range of 10 m³/(m³·h) to 20 m³/(m³·h) per unit area of the aerobic aeration tank, a hydraulic retention time in a range of 8 h to 12 h, and a dissolved oxygen concentration in a range of 2 mg/L to 4 mg/L; and when a COD removal rate for influent is higher than 80%, an ammonia nitrogen removal rate is higher than 80%, a phosphorus removal rate is higher than 85%, and the aerobic aeration tank continuously and stably operates for more than 7 days, indicating that the aerobic aeration tank is successfully started; and
in the post-anoxic-zone MABR tank, adding a carbon source fermentation solution, and maintaining a carbon to nitrogen ratio in a range of 1.2 to 2.0; turning on the blower and the aeration device; adopting a pulse aeration mode with an aerating time of 40 min and a rest time of 20 min, controlling a membrane aeration pressure in a range of 15 KPa to 20 KPa; controlling a dissolved oxygen concentration in a range of 0.2 mg/L to 0.5 mg/L; when an ammonia nitrogen removal rate is higher than 80% and a nitrate nitrogen removal rate is higher than 80% in the post-anoxic-zone MABR tank, starting returning of effluent to the anoxic-zone MABR tank; and when the ammonia nitrogen removal rate is higher than 85% and the nitrate nitrogen removal rate is higher than 85% in the post-anoxic-zone MABR tank, the post-anoxic-zone MABR tank continuously and stably operates for more than 7 days, and the sludge concentration on the biofilm of MABR is higher than or equal to 0.8 gVSS/L, indicating that the post-anoxic-zone MABR tank is successfully started; and
in a third step, load increase stage allowing the municipal wastewater to enter the continuous-flow system and flow through the anaerobic tank, the anoxic-zone MABR tank, the aerobic aeration tank, and the post-anoxic-zone MABR tank successively; in the anaerobic tank, increasing the organic load of influent to 0.2 kgCOD/(m³·d) to 0.3 kgCOD/(m³·d), increasing the influent flow rate to 15 m³/h to 25 m³/h, and shortening the hydraulic retention time to 3.0 h to 5.0 h; when the phosphorus concentration in the effluent of the anaerobic tank is 2 times to 3 times higher than the phosphorus concentration in the influent of the anaerobic tank and the anaerobic tank continuously and stably operates for more than 7 days, adjusting the organic load of influent to 0.3 kgCOD/(m³·d) to 0.4 kgCOD/(m³·d), increasing the influent flow rate to 20 m³/h to 30 m³/h, and shortening the hydraulic retention time to 2.0 h to 4.0 h; and based on such adjusting conditions, allowing the continuous-flow system to operate stably for a long time;
in the anoxic-zone MABR tank, raising the mixed liquor return ratio to 300% to 500%, adopting a pulse aeration mode with an aerating time of 35 min and a rest time of 25 min, controlling a membrane aeration pressure in a range of 17 KPa to 27 KPa, adjusting the dissolved oxygen concentration to 0.4 mg/L to 0.7 mg/L, and shortening the hydraulic retention time to 3.0 h to 5.0 h; when the ammonia nitrogen removal rate is higher than 60% and the nitrate nitrogen removal rate is higher than 80% in the anoxic-zone MABR tank and the anoxic-zone MABR tank continuously and stably operates for more than 7 days, raising the mixed liquor return ratio to 400% to 600%, adopting the pulse aeration mode with an aerating time of 30 min and a rest time of 30 min, controlling the membrane aeration pressure in a range of 20 KPa to 30 KPa, adjusting the dissolved oxygen concentration to 0.6 mg/L to 0.9 mg/L, and shortening the hydraulic retention time to 2.0 h to 4.0 h; and based on such adjusted conditions, allowing the continuous-flow system to operate stably for a long time;
in the aerobic aeration tank, shortening the hydraulic retention time to 6.0 h to 10.0 h, raising the aeration intensity to 15 m³/(m³·h) to 25 m³/(m³·h), and controlling the dissolved oxygen concentration in a range of 2.5 mg/L to 4.5 mg/L; when the COD removal rate for influent is higher than 80%, the ammonia nitrogen removal rate is higher than 80%, the phosphorus removal rate is higher than 85%, and the aerobic aeration tank continuously and stably operates for more than 7 days, shortening the hydraulic retention time to 4.0 h to 8.0 h, raising the aeration intensity to 20 m³/(m³·h) to 30 m³/(m³·h), and controlling the dissolved oxygen concentration in a range of 3.0 mg/L to 5.0 mg/L; and based on such adjusted conditions, allowing the continuous-flow system to operate stably for a long time; and
in the post-anoxic-zone MABR tank, adopting a pulse aeration mode with an aerating time of 35 min and a rest time of 25 min, controlling the membrane aeration pressure in a range of 17 KPa to 23 KPa, adjusting the dissolved oxygen concentration to 0.4 mg/L to 0.7 mg/L, and shortening the hydraulic retention time to 1.5 h to 2.5 h; when the ammonia nitrogen removal rate is higher than 85% and the nitrate nitrogen removal rate is higher than 85% in the post-anoxic-zone MABR tank and the post-anoxic-zone MABR tank continuously and stably operates for more than 7 days, adopting a pulse aeration mode with an aerating time of 30 min and a rest time of 30 min, controlling the membrane aeration pressure in a range of 19 KPa to 25 KPa, adjusting the dissolved oxygen concentration to 0.6 mg/L to 0.9 mg/L, and shortening the hydraulic retention time to 1.0 h to 2.0 h; and based on such adjusted conditions, allowing the continuous-flow system to operate stably for a long time.

The apparatus that combines continuous-flow two-stage MABR and an anaerobic fermentation reactor and can achieve the nitrogen removal from low carbon-to-nitrogen ratio wastewater based on PD/A provided in the present disclosure has the following advantages:
1. In the MABR system, a breathable membrane material is adopted to achieve the bubble-free aeration, which enables a theoretical oxygen transfer efficiency of 100% and can accurately control an oxygen concentration. This characteristic creates a unique oxygen concentration gradient for microorganisms within a biofilm, such that nitrosation bacteria, nitrifiers, and anammox bacteria can coexist and play a synergistic role in a same system, thereby achieving SND. By optimizing the transformation pathway for nitrogen, the MABR system can significantly improve the nitrogen removal efficiency. In particular, the MABR system still can maintain a high total nitrogen removal rate when used for treating low carbon-to-nitrogen ratio wastewater.
2. Anammox bacteria grow slowly, and is extremely sensitive to changes in environmental conditions, resulting in stringent growth conditions for anammox bacteria. As a result, the traditional system exhibits poor stability during an operational process, and can hardly withstand an external shock load. In contrast, the MABR system provides microorganisms with a stable attachment surface through a membrane material, which promotes the formation of a biofilm. Within the biofilm, microbial floras are distributed in a layered structure, such that different microorganisms can grow and proliferate in respective suitable microenvironments. This layered structure provides stable survival conditions for anammox bacteria, enhances the stability of the overall system, and significantly improves the tolerance ability of the system to shock loads.
3. During an actual operational process, the traditional PD/A process requires an organic carbon source. The core advantage of treating effluent from an activated sludge reactor with an anaerobic sludge fermentation tank lies in achieving the efficient recovery and recycling of a carbon source. Refractory particulate organic matters in sludge are hydrolyzed into soluble volatile fatty acids (VFAs) through anaerobic fermentation. The soluble volatile fatty acids (VFAs) can be reused as a high-quality internal carbon source in the anoxic-zone MABR tank, which can significantly reduce the dependence on external carbon sources. Therefore, the apparatus is especially suitable for the treatment of low carbon-to-nitrogen ratio wastewater.

### BRIEF DESCRIPTION OF THE DRAWING

In order to provide a clearer explanation of the technical solutions in the embodiments or related technologies of the present disclosure, a brief introduction will be given to the drawings required for the embodiments. Apparently, the drawings described below are only some embodiments of the present disclosure. For those skilled in the art, other drawings can be obtained based on these drawings without creative effort.

FIG. 1 is a schematic structural diagram of an apparatus for implementing advanced nitrogen and phosphorus removal from low carbon-to-nitrogen ratio wastewater through autotrophic coupling with heterotrophic based on a continuous-flow membrane aerated biofilm reactor (MABR) according to embodiments of the present disclosure.

Reference numerals in drawings:
1-municipal wastewater tank;
2-anaerobic tank;
2.1-first water inlet pipe;
2.2-first peristaltic pump;
2.3-first water inlet;
2.4-first pH probe;
2.5-first DO probe;
2.6-first multi-parameter measuring instrument;
2.7-first sludge inlet;
2.8-first stirring device;
3-anoxic-zone MABR tank;
3.1-first MABR membrane module;
3.2-first gas supply pipe;
3.3-second multi-parameter measuring instrument;
3.4-second pH probe;
3.5-second DO probe;
3.6-second stirring device;
3.7-internal return water inlet;
3.8-second pressure sensor;
3.9-second aeration valve;
3.10-blower;
4-aerobic aeration tank;
4.1-third stirring device;
4.2-fourth stirring device;
4.3-second gas supply pipe;
4.4-aerator head;
4.5-second pressure sensor;
4.6-second aeration valve;
5-post-anoxic-zone MABR tank;
5.1-second MABR membrane module;
5.2-internal carbon source return port;
5.3-third gas supply pipe;
5.4-third aeration valve;
5.5-third pressure sensor;
5.6-first water outlet;
5.7-second peristaltic pump;
5.8-return pipe;
6-sedimentation tank;
6.1-second water inlet;
6.2-third peristaltic pump;
6.3-first water outlet pipe;
6.4-first sludge discharge pump;
6.5-first sludge delivery pipe;
6.6-second sludge discharge pump;
6.7-second sludge delivery pipe;
6.8-second water outlet;
7-sludge carbon source extraction system;
7.1-second sludge inlet;
7.2-exhaust port;
7.3-condensated water outlet;
7.4-third water outlet;
7.5-condensated water inlet;
7.6-fifth stirring device;
7.7-fourth peristaltic pump;
7.8-second water outlet pipe;
8-intermediate water tank;
8.1-a fifth peristaltic pump;
8.2-a carbon source pipe; and
9-effluent tank.

### DETAILED DESCRIPTION OF THE DISCLOSURE

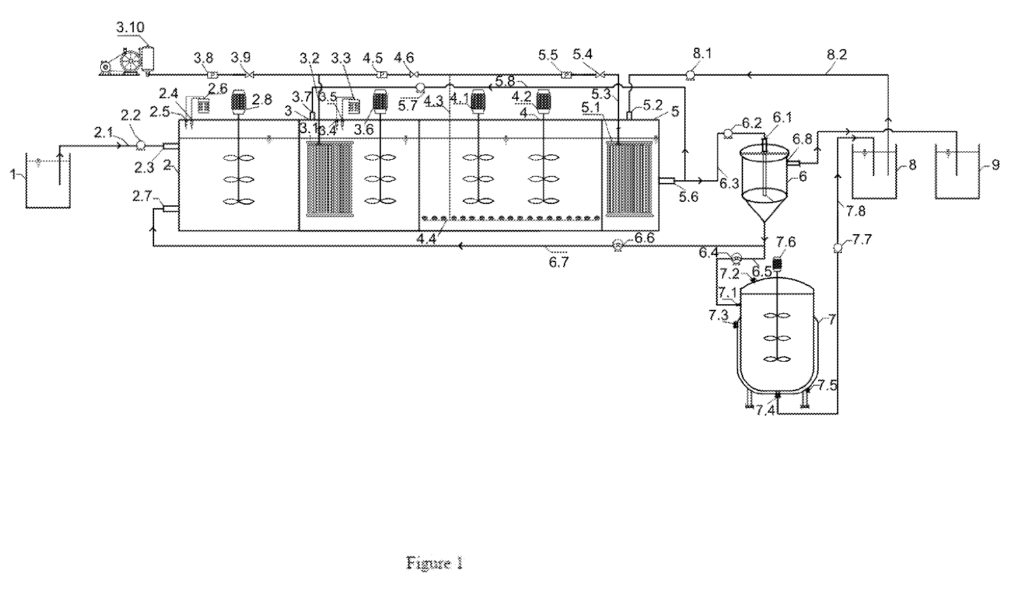

The present disclosure is further illustrated in combination with the drawing and embodiments. As shown in FIG. 1, an apparatus for implementing autotrophic/heterotrophic coupled advanced nitrogen and phosphorus removal from low carbon-to-nitrogen ratio wastewater using a continuous-flow membrane aerated biofilm reactor is provided, including a municipal wastewater tank 1, an anaerobic tank 2, an anoxic-zone MABR tank 3, an aerobic aeration tank 4, a post-anoxic-zone MABR tank 5, a sedimentation tank 6, a sludge carbon source extraction system 7, an intermediate water tank 8, and an effluent tank 9. The anaerobic tank 2 is provided with a first water inlet pipe 2.1, a first peristaltic pump 2.2, a first water inlet 2.3, a first pH probe 2.4, a first DO probe 2.5, a first multi-parameter measuring instrument 2.6, a first sludge inlet 2.7, and a first stirring device 2.8. The anoxic-zone MABR tank 3 is provided with a first MABR membrane module 3.1, a first gas supply pipe 3.2, a second multi-parameter measuring instrument 3.3, a second pH probe 3.4, a second DO probe 3.5, a second stirring device 3.6, an internal return water inlet 3.7, a first pressure sensor 3.8, a first aeration valve 3.9, and a blower 3.10. The aerobic aeration tank 4 is provided with a third stirring device 4.1, a fourth stirring device 4.2, a second gas supply pipe 4.3, an aerator head 4.4, a second pressure sensor 4.5 and a second aeration valve 4.6. The post-anoxic-zone MABR tank 5 is provided with a second MABR membrane module 5.1, an internal carbon source return port 5.2, a third gas supply pipe 5.3, a third aeration valve 5.4, a third pressure sensor 5.5, a first water outlet 5.6, a second peristaltic pump 5.7, and a return pipe 5.8. The sedimentation tank 6 is provided with a second water inlet 6.1, a third peristaltic pump 6.2, a first water outlet pipe 6.3, a first sludge discharge pump 6.4, a first sludge delivery pipe 6.5, a second sludge discharge pump 6.6, a second sludge delivery pipe 6.7, and a second water outlet 6.8. The sludge carbon source extraction system 7 is provided with a second sludge inlet 7.1, an exhaust port 7.2, a condensated water outlet 7.3, a third water outlet 7.4, a condensated water inlet 7.5, a fifth stirring device 7.6, a fourth peristaltic pump 7.7, and a second water outlet pipe 7.8. The intermediate water tank 8 is provided with a fifth peristaltic pump 8.1 and a carbon source pipe 8.2. The municipal wastewater tank 1 is connected to the anaerobic tank 2 through the first peristaltic pump 2.2. The anaerobic tank 2, the anoxic-zone MABR tank 3, the aerobic aeration tank 4, and the post-anoxic-zone MABR tank 5 are connected sequentially in the continuous-flow system. The post-anoxic-zone MABR tank 5 is connected to the sedimentation tank 6 through the third peristaltic pump 6.2. A part of effluent is returned to the anoxic-zone MABR tank 3 through the second peristaltic pump 5.7. effluent from the sedimentation tank 6 flows to the effluent tank 9. A part of sludge is delivered to the sludge carbon source extraction system 7 for fermentation through the first sludge discharge pump 6.4, and the remaining part of the sludge is returned to the anaerobic tank 2 through the second sludge discharge pump 6.6. The sludge carbon source extraction system 7 is connected to the intermediate water tank 8 through the fourth peristaltic pump 7.7. The intermediate water tank 8 is connected to the post-anoxic-zone MABR tank 5 through the fifth peristaltic pump 8.1 to supply a carbon source for the post-anoxic-zone MABR tank.

A method for implementing autotrophic/heterotrophic coupled advanced nitrogen and phosphorus removal from low carbon-to-nitrogen ratio wastewater using a continuous-flow membrane aerated biofilm reactor is provided, including the following steps:

1. Setting an operating mode of a continuous-flow system:

The continuous-flow system is divided into an anaerobic tank 2, an anoxic-zone MABR tank 3, an aerobic aeration tank 4, and a post-anoxic-zone MABR tank 5 that are in a volume ratio of 2:2:3:1. Municipal wastewater is allowed to enter the anaerobic tank 2, the anoxic-zone MABR tank 3, the aerobic aeration tank 4, and the post-anoxic-zone MABR tank of the continuous-flow system successively. Excess sludge is allowed to enter a sludge carbon source extraction system 7. A sludge fermentation product is allowed to enter the post-anoxic-zone MABR tank 5 for partial denitrification. Return sludge is returned to the anaerobic tank 2. effluent from the post-anoxic-zone MABR tank 5 is returned partially to the anoxic-zone MABR tank 3 to achieve advanced nitrogen removal.

2. Setting parameters, starting and operating the system:

At a startup stage, sludge is inoculated into each reaction tank; the excess sludge from a wastewater treatment plant is inoculated into the anaerobic tank 2 and makes the anaerobic tank 2 with a sludge concentration of 4.5 gVSS/L; the excess sludge and anammox sludge from the wastewater treatment plant are inoculated into the anoxic-zone MABR tank 3 and make the anoxic-zone MABR tank 3 with a sludge concentration of 6.0 gVSS/L; the excess sludge from the wastewater treatment plant is inoculated into the aerobic aeration tank 4 and makes the aerobic aeration tank 4 with a sludge concentration of 3.5 gVSS/L; and the excess sludge and the anammox sludge from the wastewater treatment plant are inoculated into the post-anoxic-zone MABR tank and make the post-anoxic-zone MABR tank with a sludge concentration of 6 gVSS/L. The effluent from the post-anoxic-zone MABR tank 5 is returned partially to the anoxic-zone MABR tank 3, where a mixed liquor return ratio is 300%, and a sludge return ratio in a sedimentation tank 6 is 75%.

In the anaerobic tank 2, initially, an organic load of influent is set to 0.15 kgCOD/(m³·d), an influent flow rate is set to 15 m³/h, a hydraulic retention time is set to 5.0 h, and a dissolved oxygen is controlled below 0.2 mg/L. When a phosphorus concentration in effluent of the anaerobic tank 2 is 2 times to 3 times higher than a phosphorus concentration in influent of the anaerobic tank 2, the anaerobic tank 2 continuously and stably operates for more than 7 days, and a sludge concentration in the anaerobic tank 2 is greater than or equal to 3.0 gVSS/L, it indicates that the anaerobic tank 2 is successfully activated.

In the anoxic-zone MABR tank 3, a blower 3.10 and an aeration device are turned on. A pulse aeration mode with an aerating time of 40 min and a rest time of 20 min is adopted, a membrane aeration pressure is controlled at 15 KPa to 25 KPa, a dissolved oxygen concentration is controlled at 0.2 mg/L to 0.5 mg/L, and a hydraulic retention time is controlled at 5 h. When an ammonia nitrogen removal rate is higher than 60% and a nitrate nitrogen removal rate is higher than 80% in the anoxic-zone MABR tank 3, the anoxic-zone MABR tank 3 continuously and stably operates for more than 7 days, and a sludge concentration on a biofilm of MABR is higher than or equal to 1.0 gVSS/L, it indicates that the anoxic-zone MABR tank 3 is successfully activated.

In the aerobic aeration tank 4, a blower 3.10 and an aeration device are turned on. An aeration intensity is controlled at 15 m³/(m³·h) per unit area of the aerobic aeration tank 4, a hydraulic retention time is controlled at 10 h, and a dissolved oxygen concentration is controlled at2 mg/L to 4 mg/L. When a COD removal rate for influent is higher than 80%, an ammonia nitrogen removal rate is higher than 80%, a phosphorus removal rate is higher than 85%, and the aerobic aeration tank 4 continuously and stably operates for more than 7 days, it indicates that the aerobic aeration tank 4 is successfully activated.

In the post-anoxic-zone MABR tank 5, a carbon source fermentation solution is added to maintain a carbon to nitrogen ratio at 1.6. A blower 3.10 and an aeration device are turned on. A pulse aeration mode with an aerating time of 40 min and a rest time of 20 min is adopted, a membrane aeration pressure is controlled at 15 KPa to 20 KPa, a dissolved oxygen concentration is controlled at 0.2 mg/L to 0.5 mg/L. When an ammonia nitrogen removal rate is higher than 80% and a nitrate nitrogen removal rate is higher than 80% in the post-anoxic-zone MABR tank 5, returning of effluent to the anoxic-zone MABR tank 3 is started. When the ammonia nitrogen removal rate is higher than 85% and the nitrate nitrogen removal rate is higher than 85% in the post-anoxic-zone MABR tank 5, the post-anoxic-zone MABR tank 5 continuously and stably operates for more than 7 days, and the sludge concentration on the biofilm of MABR is higher than or equal to 0.8 gVSS/L, it indicates that the post-anoxic-zone MABR tank 5 is successfully started.

3. Load increase stage

The municipal wastewater is allowed to enter the continuous-flow system and flows through the anaerobic tank 2, the anoxic-zone MABR tank 3, the aerobic aeration tank 4, and the post-anoxic-zone MABR tank 5 successively. In the anaerobic tank 2, the organic load of influent is increased to 0.25 kgCOD/(m³·d), the influent flow rate is increased to 20 m³/h, and the hydraulic retention time is shortened to 4.0 h. When the phosphorus concentration in the effluent of the anaerobic tank 2 is 2 times to 3 times higher than the phosphorus concentration in the influent of the anaerobic tank 2, and the anaerobic tank 2 continuously and stably operates for more than 7 days, the organic load of influent is adjusted to 0.35 kgCOD/(m³·d), the influent flow rate is increased to 25 m³/h, and the hydraulic retention time is shortened to 3.0 h. The continuous-flow system is allowed to operate stably for a long time under the conditions that the phosphorus concentration in the effluent of the anaerobic tank 2 is 2 times to 3 times higher than the phosphorus concentration in the influent of the anaerobic tank 2 and the anaerobic tank 2 continuously and stably operates for more than 7 days.

In the anoxic-zone MABR tank 3, the mixed liquor return ratio is raised to 400%, the pulse aeration mode with an aerating time of 35 min and a rest time of 25 min is adopted, the membrane aeration pressure is controlled at 22 KPa, the dissolved oxygen concentration is adjusted to 0.4 mg/L to 0.7 mg/L, and the hydraulic retention time is shortened to 4.0 h. When the ammonia nitrogen removal rate is higher than 60% and the nitrate nitrogen removal rate is higher than 80% in the anoxic-zone MABR tank 3 and the anoxic-zone MABR tank 3 continuously and stably operates for more than 7 days, the mixed liquor return ratio is raised to 500%, the pulse aeration mode with an aerating time of 30 min and a rest time of 30 min is adopted, the membrane aeration pressure is controlled at 20 KPa to 30 KPa, the dissolved oxygen concentration is adjusted to 0.6 mg/L to 0.9 mg/L, and the hydraulic retention time is shortened to 3.0 h. The continuous-flow system is allowed to operate stably for a long time under the conditions that the the ammonia nitrogen removal rate is higher than 60% and the nitrate nitrogen removal rate is higher than 80% in the anoxic-zone MABR tank 3 and the anoxic-zone MABR tank 3 continuously and stably operates for more than 7 days.

In the aerobic aeration tank 4, the hydraulic retention time is shortened to 8.0 h, the aeration intensity is raised to 15 m³/(m³·h) to 25 m³/(m³·h), and the dissolved oxygen concentration is controlled at 2.5 mg/L to 4.5 mg/L. When the COD removal rate for influent is higher than 80%, the ammonia nitrogen removal rate is higher than 80%, the phosphorus removal rate is higher than 85%, and the aerobic aeration tank 4 continuously and stably operates for more than 7 days, the hydraulic retention time is shortened to 6.0 h, the aeration intensity is raised to 25 m³/(m³·h), and the dissolved oxygen concentration is controlled at 4.0 mg/L. The continuous-flow system is allowed to operate stably for a long time under the conditions that the COD removal rate for influent is higher than 80%, the ammonia nitrogen removal rate is higher than 80%, the phosphorus removal rate is higher than 85%, and the aerobic aeration tank 4 continuously and stably operates for more than 7 days.

In the post-anoxic-zone MABR tank 5, the pulse aeration mode with an aerating time of 35 min and a rest time of 25 min is adopted, the membrane aeration pressure is controlled at 17 KPa to 23 KPa, the dissolved oxygen concentration is adjusted to 0.4 mg/L to 0.7 mg/L, and the hydraulic retention time is shortened to 2.0 h. When the ammonia nitrogen removal rate is higher than 85% and the nitrate nitrogen removal rate is higher than 85% in the post-anoxic-zone MABR tank 5 and the post-anoxic-zone MABR tank 5 continuously and stably operates for more than 7 days, the pulse aeration mode with an aerating time of 30 min and a rest time of 30 min is adopted, the membrane aeration pressure is controlled at 19 KPa to 25 KPa, the dissolved oxygen concentration is adjusted to 0.6 mg/L to 0.9 mg/L, and the hydraulic retention time is shortened to 1.5 h. The continuous-flow system is allowed to operate stably for a long time under the conditions that the ammonia nitrogen removal rate is higher than 85% and the nitrate nitrogen removal rate is higher than 85% in the post-anoxic-zone MABR tank 5 and the post-anoxic-zone MABR tank 5 continuously and stably operates for more than 7 days.

Specifically, test water comes from a municipal domestic wastewater treatment plant, with an average ammonia nitrogen concentration of 98.2 mg/L, an average phosphorus concentration of 6.3 mg/L, and a COD concentration of 203.7 mg/L. After 120 days of long-time operating, an ammonia nitrogen concentration of effluent is 8.3 mg/L, a nitrate nitrogen removal rate is 86.7%, and a phosphorus concentration of effluent is 0.4 mg/L, achieving the stable advanced nitrogen removal from municipal wastewater.

In the present disclosure, specific examples are applied to explain the principles and implementations of the present disclosure. The description of the above embodiments are only used to help understand the method and core idea of the present disclosure. In addition, in accordance with the ideas of the present disclosure, for those skilled in the art, changes can be made in terms of the specific implementation and the application scope. In summary, the content of the specification should not be construed as limiting the present disclosure.

What is claimed is:

1. An apparatus for implementing advanced nitrogen and phosphorus removal from low carbon-to-nitrogen ratio wastewater through autotrophic coupling with heterotrophic based on a continuous-flow membrane aerated biofilm reactor (MABR), comprising: a municipal wastewater tank (1), an anaerobic tank (2), an anoxic-zone MABR tank (3), an aerobic aeration tank (4), a post-anoxic-zone MABR tank (5), a sedimentation tank (6), a sludge carbon source extraction system (7), an intermediate water tank (8), and an effluent tank (9); wherein
the anaerobic tank (2) is provided with a first water inlet pipe (2.1), a first peristaltic pump (2.2), a first water inlet (2.3), a first pH probe (2.4), a first dissolved oxygen (DO) probe (2.5), a first multi-parameter measuring instrument (2.6), a first sludge inlet (2.7), and a first stirring device (2.8);
the anoxic-zone MABR tank (3) is provided with a first MABR membrane module (3.1), a first gas supply pipe (3.2), a second multi-parameter measuring instrument (3.3), a second pH probe (3.4), a second DO probe (3.5), a second stirring device (3.6), an internal return water inlet (3.7), a first pressure sensor (3.8), a first aeration valve (3.9), and a blower (3.10);
the aerobic aeration tank (4) is provided with a third stirring device (4.1), a fourth stirring device (4.2), a second gas supply pipe (4.3), an aerator head (4.4), a second pressure sensor (4.5), and a second aeration valve (4.6);
the post-anoxic-zone MABR tank (5) is provided with a second MABR membrane module (5.1), an internal carbon source return port (5.2), a third gas supply pipe (5.3), a third aeration valve (5.4), a third pressure sensor (5.5), a first water outlet (5.6), a second peristaltic pump (5.7), and a return pipe (5.8);
the sedimentation tank (6) is provided with a second water inlet (6.1), a third peristaltic pump (6.2), a first water outlet pipe (6.3), a first sludge discharge pump (6.4), a first sludge delivery pipe (6.5), a second sludge discharge pump (6.6), a second sludge delivery pipe (6.7), and a second water outlet (6.8);
the sludge carbon source extraction system (7) is provided with a second sludge inlet (7.1), an exhaust port (7.2), a condensated water outlet (7.3), a third water outlet (7.4), a condensated water inlet (7.5), a fifth stirring device (7.6), a fourth peristaltic pump (7.7), and a second water outlet pipe (7.8);
the intermediate water tank (8) is provided with a fifth peristaltic pump (8.1) and a carbon source pipe (8.2); and wherein
the municipal wastewater tank (1) is connected to the anaerobic tank (2) through the first peristaltic pump (2.2); the anaerobic tank (2), the anoxic-zone MABR tank (3), the aerobic aeration tank (4), and the post-anoxic-zone MABR tank (5) are connected sequentially in the continuous-flow system; the post-anoxic-zone MABR tank (5) is connected to the sedimentation tank (6) through the third peristaltic pump (6.2); a part of effluent is returned to the anoxic-zone MABR tank (3) through the second peristaltic pump (5.7); effluent from the sedimentation tank (6) flows to the effluent tank (9); excess sludge is delivered to the sludge carbon source extraction system (7) for fermentation through the first sludge discharge pump (6.4), and return sludge is returned to the anaerobic tank (2) through the second sludge discharge pump (6.6); and the sludge carbon source extraction system (7) is connected to the intermediate water tank (8) through the fourth peristaltic pump (7.7), and the intermediate water tank (8) is connected to the post-anoxic-zone MABR tank through the fifth peristaltic pump (8.1) to supply a carbon source for the post-anoxic-zone MABR tank (5).

2. A method for using the apparatus for implementing advanced nitrogen and phosphorus removal from low carbon-to-nitrogen ratio wastewater through autotrophic coupling with heterotrophic based on continuous-flow membrane aerated biofilm reactor (MABR) according to claim 1, and the method comprising the following steps:
in a first step, setting an operating mode of a continuous-flow system
dividing the continuous-flow system into an anaerobic tank (2), an anoxic-zone MABR tank (3), an aerobic aeration tank (4), and a post-anoxic-zone MABR tank (5) that are in a volume ratio range of 2:2:2:1 to 2:2:4:1; allowing municipal wastewater to enter the anaerobic tank, the anoxic-zone MABR tank (3), the aerobic aeration tank (4), and the post-anoxic-zone MABR tank (5) of the continuous-flow system successively; allowing excess sludge to enter a sludge carbon source extraction system (7); allowing a sludge fermentation product to enter the post-anoxic-zone MABR tank (5) supplied for partial denitrification (PD); returning return sludge to the anaerobic tank (2); and partially returning effluent from the post-anoxic-zone MABR tank (5) to the anoxic-zone MABR tank (3), achieving advanced nitrogen removal;
in a second step, setting parameters and starting and operating
at a startup stage, inoculating sludge into each reaction tank; inoculating excess sludge from a wastewater treatment plant into the anaerobic tank (2) and making the anaerobic tank (2) within a sludge concentration range of 3.0 gVSS/L to 6.0 gVSS/L; inoculating the excess sludge and anammox sludge from the wastewater treatment plant into the anoxic-zone MABR tank (3) and making the anoxic-zone MABR tank (3) within a sludge concentration range of 4.0 gVSS/L to 8.0 gVSS/L; inoculating the excess sludge from the wastewater treatment plant into the aerobic aeration tank (4) and making the aerobic aeration tank (4) within a sludge concentration range of 2.0 gVSS/L to 5.0 gVSS/L; and inoculating the excess sludge and the anammox sludge from the wastewater treatment plant into the post-anoxic-zone MABR tank (5) and making the post-anoxic-zone MABR tank (5) within a sludge concentration range of 4.0 gVSS/L to 8.0 gVSS/L; and partially returning the effluent from the post-anoxic-zone MABR tank (5) to the anoxic-zone MABR tank (3), wherein a mixed liquor return ratio is in a range of 200% to 400%, and a sludge return ratio in a sedimentation tank (6) is in a range of 70% to 80%;
in the anaerobic tank (2), initially, setting an organic load of influent to 0.1 kgCOD/(m³·d) to 0.2 kgCOD/(m³·d), an influent flow rate to 10 m³/h to 20 m³/h, a hydraulic retention time to 4.0 h to 6.0 h, and a dissolved oxygen below 0.2 mg/L; and when a phosphorus concentration in effluent of the anaerobic tank (2) is 2 times to 3 times higher than a phosphorus concentration in influent of the anaerobic tank (2), the anaerobic tank (2) continuously and stably operates for more than 7 days, and a sludge concentration in the anaerobic tank (2) is greater than or equal to 3.0 gVSS/L, indicating that the anaerobic tank (2) is successfully started;
in the anoxic-zone MABR tank (3), turning on a blower (3.10) and an aeration device; adopting a pulse aeration mode with an aerating time of 40 min and a rest time of 20 min, controlling a membrane aeration pressure in a range of 15 KPa to 25 KPa; controlling a dissolved oxygen concentration in a range of 0.2 mg/L to 0.5 mg/L and a hydraulic retention time in a range of 4 h to 6 h; and when an ammonia nitrogen removal rate is higher than 60% and a nitrate nitrogen removal rate is higher than 80% in the anoxic-zone MABR tank (3), the anoxic-zone MABR tank (3) continuously and stably operates for more than 7 days, and a sludge concentration on a biofilm of MABR is higher than or equal to 1.0 gVSS/L, indicating that the anoxic-zone MABR tank (3) is successfully started;
in the aerobic aeration tank (4), turning on a blower (3.10) and an aeration device; controlling an aeration intensity in a range of 10 m³/(m³·h) to 20 m³/(m³·h) per unit area of the aerobic aeration tank (4), a hydraulic retention time in a range of 8 h to 12 h, and a dissolved oxygen concentration in a range of 2 mg/L to 4 mg/L; and when a chemical oxygen demand (COD) removal rate for influent is higher than 80%, an ammonia nitrogen removal rate is higher than 80%, a phosphorus removal rate is higher than 85%, and the aerobic aeration tank (4) continuously and stably operates for more than 7 days, indicating that the aerobic aeration tank (4) is successfully started; and
in the post-anoxic-zone MABR tank (5), adding a carbon source fermentation solution, and maintaining a carbon to nitrogen ratio in a range of 1.2 to 2.0; turning on the blower (3.10) and the aeration device; adopting a pulse aeration mode with an aerating time of 40 min and a rest time of 20 min, controlling a membrane aeration pressure in a range of 15 KPa to 20 KPa; controlling a dissolved oxygen concentration in a range of 0.2 mg/L to 0.5 mg/L; when an ammonia nitrogen removal rate is higher than 80% and a nitrate nitrogen removal rate is higher than 80% in the post-anoxic-zone MABR tank (5), starting returning of effluent to the anoxic-zone MABR tank (3); and when the ammonia nitrogen removal rate is higher than 85% and the nitrate nitrogen removal rate is higher than 85% in the post-anoxic-zone MABR tank (5), the post-anoxic-zone MABR tank (5) continuously and stably operates for more than 7 days, and the sludge concentration on the biofilm of MABR is higher than or equal to 0.8 gVSS/L, indicating that the post-anoxic-zone MABR tank (5) is successfully started; and
in a third step, load increase stage
allowing the municipal wastewater to enter the continuous-flow system and flow through the anaerobic tank (2), the anoxic-zone MABR tank (3), the aerobic aeration tank (4), and the post-anoxic-zone MABR tank (5) successively; in the anaerobic tank (2), increasing the organic load of influent to 0.2 kgCOD/(m³·d) to 0.3 kgCOD/(m³·d), increasing the influent flow rate to 15 m³/h to 25 m³/h, and shortening the hydraulic retention time to 3.0 h to 5.0 h; when the phosphorus concentration in the effluent of the anaerobic tank (2) is 2 times to 3 times higher than the phosphorus concentration in the influent of the anaerobic tank (2) and the anaerobic tank (2) continuously and stably operates for more than 7 days, adjusting the organic load of influent to 0.3 kgCOD/(m³·d) to 0.4 kgCOD/(m³·d), increasing the influent flow rate to 20 m³/h to 30 m³/h, shortening the hydraulic retention time to 2.0 h to 4.0 h, and allowing a long-term operation based on such adjusted conditions;
in the anoxic-zone MABR tank (3), raising the mixed liquor return ratio to 300% to 500%, adopting a pulse aeration mode with an aerating time of 35 min and a rest time of 25 min, controlling a membrane aeration pressure in a range of 17 KPa to 27 KPa, adjusting the dissolved oxygen concentration to 0.4 mg/L to 0.7 mg/L, and shortening the hydraulic retention time to 3.0 h to 5.0 h; when the ammonia nitrogen removal rate is higher than 60% and the nitrate nitrogen removal rate is higher than 80% in the anoxic-zone MABR tank (3) and the anoxic-zone MABR tank (3) continuously and stably operates for more than 7 days, raising the mixed liquor return ratio to 400% to 600%, adopting the pulse aeration mode with an aerating time of 30 min and a rest time of 30 min, controlling the membrane aeration pressure in a range of 20 KPa to 30 KPa, adjusting the dissolved oxygen concentration to 0.6 mg/L to 0.9 mg/L, and shortening the hydraulic retention time to 2.0 h to 4.0 h, and allowing a long-term operation based on such adjusted conditions;
in the aerobic aeration tank (4), shortening the hydraulic retention time to 6.0 h to 10.0 h, raising the aeration intensity to 15 m³/(m³·h) to 25 m³/(m³·h), and controlling the dissolved oxygen concentration in a range of 2.5 mg/L to 4.5 mg/L; when the COD removal rate for influent is higher than 80%, the ammonia nitrogen removal rate is higher than 80%, the phosphorus removal rate is higher than 85%, and the aerobic aeration tank (4) continuously and stably operates for more than 7 days, shortening the hydraulic retention time to 4.0 h to 8.0 h, raising the aeration intensity to 20 m³/(m³·h) to 30 m³/(m³·h), and controlling the dissolved oxygen concentration in a range of 3.0 mg/L to 5.0 mg/L, and allowing a long-term operation based on such adjusted conditions; and
in the post-anoxic-zone MABR tank (5), adopting a pulse aeration mode with an aerating time of 35 min and a rest time of 25 min, controlling the membrane aeration pressure in a range of 17 KPa to 23 KPa, adjusting the dissolved oxygen concentration to 0.4 mg/L to 0.7 mg/L, and shortening the hydraulic retention time to 1.5 h to 2.5 h; when the ammonia nitrogen removal rate is higher than 85% and the nitrate nitrogen removal rate is higher than 85% in the post-anoxic-zone MABR tank (5) and the post-anoxic-zone MABR tank (5) continuously and stably operates for more than 7 days, adopting a pulse aeration mode with an aerating time of 30 min and a rest time of 30 min, controlling the membrane aeration pressure in a range of 19 KPa to 25 KPa, adjusting the dissolved oxygen concentration to 0.6 mg/L to 0.9 mg/L, and shortening the hydraulic retention time to 1.0 h to 2.0 h, and allowing a long-term operation based on such adjusted conditions.
